(19) United States
(12) Patent Application Publication
(10) Pub. No.: US 2025/0305530 A1
(43) Pub. Date: Oct. 2, 2025

(54) BLIND FASTENER

(71) Applicant: Howmet Aerospace Inc., Pittsburgh, PA (US)

(72) Inventors: Luke L. Haylock, Culver City, CA (US); Todd A. Balls, Pittsburgh, PA (US); Po-Yu Chang, Pittsburgh, PA (US)

(21) Appl. No.: 19/192,296

(22) Filed: Apr. 28, 2025

Related U.S. Application Data
(63) Continuation of application No. PCT/US2023/085453, filed on Dec. 21, 2023.
(60) Provisional application No. 63/439,405, filed on Jan. 17, 2023.

(51) Int. Cl. F16B 19/10

(52) U.S. Cl. CPC F16B 19/1054; F16B 19/1072

(57) ABSTRACT

A fastener includes a sleeve comprising first and second ends, a tubular portion having external and internal surfaces, a groove formed within the external surface between the first and second ends, and an internal thread located within the internal surface at the second end. The fastener includes a core bolt comprising a cylindrical portion, an external threaded portion, and a thread runout between the cylindrical portion and the threaded portion. The core bolt is configured to be disposed within the sleeve. The external threaded portion is configured to threadedly engage the internal thread of the sleeve. An installation motion of the core bolt within the sleeve generates a compressive load on the sleeve. The groove is configured to facilitate a formation of a bulb in the sleeve in response to the compressive load.

### CROSS-REFERENCE TO RELATED APPLICATION

This application is a continuation of PCT Patent Application Serial No. PCT/US2023/085453, filed Dec. 21, 2023, entitled “BLIND FASTENER,” which relates to and claims the benefit of U.S. Provisional Patent Application Ser. No. 63/439,405, filed Jan. 17, 2023, entitled “BLIND FASTENER,” the contents of which are incorporated herein by reference in its entirety.

### FIELD OF THE INVENTION

The present invention relates to fasteners and, more particularly, to blind fasteners for securing workpieces together.

### BACKGROUND

Blind fasteners are commonly used to secure a plurality of work pieces together when limited physical or visible access is available on a blind or non-accessible side of one of the workpieces. There is a trend toward using carbon fiber reinforced composites for aircraft structures, as these materials combine good strength-to-weight ratio, stiffness, and resistance to fatigue induced damage, but they often have low stiffness and strength across the thickness. There is also a trend toward natural laminar and hybrid laminar flow wing designs for greater fuel efficiency. Such wings generally have thinner cross sections with limited access inside the wings.

Carbon fiber reinforced composites are typically composed of a combination of a binding polymer, commonly referred to as the matrix, and high strength carbon fibers. The orientation of the carbon fiber, the matrix to fiber ratio and composition of both the fibers and the matrix can be tailored to achieve specific target properties for specific applications. The mechanical, electrical, and environmental properties of carbon fiber reinforced composites can also be affected by various types of additives which can be introduced to the binding matrix.

A wide range of fabrication techniques have been developed, but many employ some sort of layered fabrication process, which involves combining fibers into unidirectional or woven fabric layers, and which are then stacked onto each other in a quasi-isotropic layup, e.g., 0°, +60°, or −60° relative to each other. In some cases, the matrix is combined with individual layers. In other cases, the matrix is infused into the stack after the individual layers have been stacked. The two-dimensional stacked layered construction is the inherent cause of the low stiffness and strength across the thickness, which is perpendicular to the direction of the fibers.

Thus, the development of composite aircraft has led to a greater demand for mechanical fasteners which combine high clamping force normal to the direction of the fibers and a large bulb on the blind side to distribute the clamping force, and, thus, reduce the bearing stress between the bulb and the composite structure. Additionally, there is a need to minimize the bearing stress at the corner where the fastener hole intersects the back side surface of the structure to prevent delamination of the composite at this location.

### SUMMARY

In some embodiments, a fastener includes a sleeve comprising a first end and a second end opposite the first end; a tubular portion having an external surface and an internal surface; wherein a groove is formed within the external surface between the first end and the second end; wherein an internal thread is formed within the internal surface at the second end, and a head is located at the first end; and a core bolt including a first end and a second end opposite the first end of the core bolt, a cylindrical portion proximate to the first end of the core bolt, an external threaded portion proximate to the second end of the core bolt, and a thread runout between the cylindrical portion and the threaded portion, wherein the core bolt is configured to be disposed within the sleeve, and wherein the external threaded portion is configured to threadedly engage the internal thread of the sleeve, wherein an installation motion of the core bolt within the sleeve generates a compressive load on the sleeve, and wherein the groove is configured to facilitate a formation of a bulb in the sleeve in response to the compressive load.

In some embodiments, the groove has a depth of 0.001 inch to 0.005 inch. In some embodiments, the groove has a width of 0.06 inch to 0.15 inch. In some embodiments, the groove circumferentially extends around the sleeve. In some embodiments, the groove circumferentially extends around an entirety of a diameter of the sleeve. In some embodiments, the groove circumferentially extends partially around a diameter of the sleeve. In some embodiments, the groove includes a first boundary and a second boundary, wherein the first boundary circumferentially extends around the sleeve, and wherein the second boundary circumferentially extends around the sleeve.

In some embodiments, a blind side grip line of the first one of the plurality of workpieces is between the first boundary and the second boundary of the groove. In some embodiments, the blind side grip line of the first one of the plurality of workpieces is proximate to the first boundary. In some embodiments, a blind side grip line of the first one of the workpieces is substantially aligned with the first boundary. In some embodiments, the blind side grip line of the first one of the workpieces is proximate to the second boundary. In some embodiments, a blind side grip line of the first one of the workpieces is substantially aligned with the second boundary.

In some embodiments, the sleeve includes a first layer on the external surface of the sleeve, wherein the first layer includes a first hardness, and a second layer on the internal surface of the sleeve, wherein the second layer includes a second hardness, and wherein the second hardness is greater than the first hardness. In some embodiments, the first layer is a coating. In some embodiments, the coating is composed of a metal-based coating. In some embodiments, the coating is selected from the group consisting of silver, gold, nickel, cadmium, copper, and lead, or alloys thereof. In some embodiments, the coating is composed of bronze. In some embodiments, the second layer is composed of an oxide layer. In some embodiments, the sleeve includes a third layer over the second layer. In some embodiments, the second layer is composed of carbon and the third layer is composed of nitrogen and carbon.

In some embodiments, the fastener further includes an insert configured to be disposed within the sleeve and encircle a portion of the core bolt proximate to the second end thereof, wherein the insert is sized and shaped to abut and be retained between the internal thread of the sleeve and the thread runout of the core bolt when the fastener is in a pre-installation position, wherein the insert is configured to be compressed between the internal thread of the sleeve and the thread runout of the core bolt by an installation motion of the core bolt with respect to the sleeve simultaneously with a generation of a compressive load on the sleeve by the installation motion of the core bolt, and wherein the insert is configured to deform simultaneously with and facilitate a formation of a bulb in the sleeve in response to compression of the insert. In some embodiments, the insert is configured to deform simultaneously with and facilitate, in conjunction with the groove, a formation of a bulb in the sleeve in response to compression of the insert.

In some embodiments, the core bolt includes an external surface, wherein the insert is configured to fill a void between the external surface of the core bolt proximate to the second end thereof and the internal surface of the sleeve proximate to the second end of the tubular portion of the sleeve, and wherein the insert is configured to provide an electrically conductive path between the sleeve and the core bolt. In some embodiments, a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener. In some embodiments, the core bolt includes a head at the first end thereof, and wherein the head of the sleeve includes a pocket sized and shaped to receive the head of the core bolt.

### BRIEF DESCRIPTION OF THE DRAWINGS

FIGS. 1 and 2 are side elevational views of some embodiments of a fastener;

FIG. 3 is a partial, side cross-sectional view of some embodiments of a fastener;

FIG. 4 is a side cross-sectional view, taken along section lines 4-4 and looking in the direction of the arrows, of the fastener of FIG. 2;

FIG. 5 is a partial cross-sectional, perspective view of some embodiments of a fastener;

FIG. 6 is a cross-sectional, perspective view of some embodiments of a fastener;

FIG. 7 is a top perspective view of some embodiments of fasteners installed in a plurality of workpieces;

FIG. 8 illustrates some embodiments of a fastener installed in a plurality of workpieces in a minimum grip condition (left figure) and maximum grip condition (right figure);

FIG. 9 illustrates some embodiments of a fastener installed in a plurality of workpieces in a minimum grip condition and maximum grip condition with a formation of corresponding bulbs of the fastener;

FIG. 10 illustrates some embodiments of a bulb formation comparison between some embodiments of a fastener having a groove (right figure) and some embodiments of a fastener without the groove (left figure) at a minimum grip condition;

FIG. 11 illustrates some embodiments of a bulb formation comparison between some embodiments of a fastener having a groove (right figure) and some embodiments of a fastener without the groove (left figure) at a maximum grip condition;

FIG. 12 illustrates a graph of bulb size versus drive angle for a bulb formation comparison between some embodiments of a fastener having a groove and some embodiments of a fastener without the groove at a minimum grip condition;

FIG. 13 illustrates a graph of bulb size versus drive angle for a bulb formation comparison between some embodiments of a fastener having the groove and some embodiments of a fastener without the groove at a maximum grip condition;

FIG. 14 illustrates a graph of contact nodal force versus drive angle of a comparison between some embodiments of a fastener having a groove and some embodiments of a fastener without the groove at a minimum grip condition;

FIG. 15 illustrates a graph of contact nodal force versus drive angle for a comparison between some embodiments of a fastener having a groove and some embodiments of a fastener without the groove at a maximum grip condition;

FIG. 16 is a partial cross-sectional, perspective view of some embodiments of a fastener;

FIG. 17 is a cross-sectional, perspective view of some embodiments of a fastener;

FIG. 18 is a perspective view of some embodiments of an insert employed by the fastener; and

FIGS. 19 and 20 are side elevational and cross-sectional side elevational views of some embodiments of the fastener shown in FIGS. 16 through 17, the fastener being fully installed in the plurality of workpieces.

### DETAILED DESCRIPTION

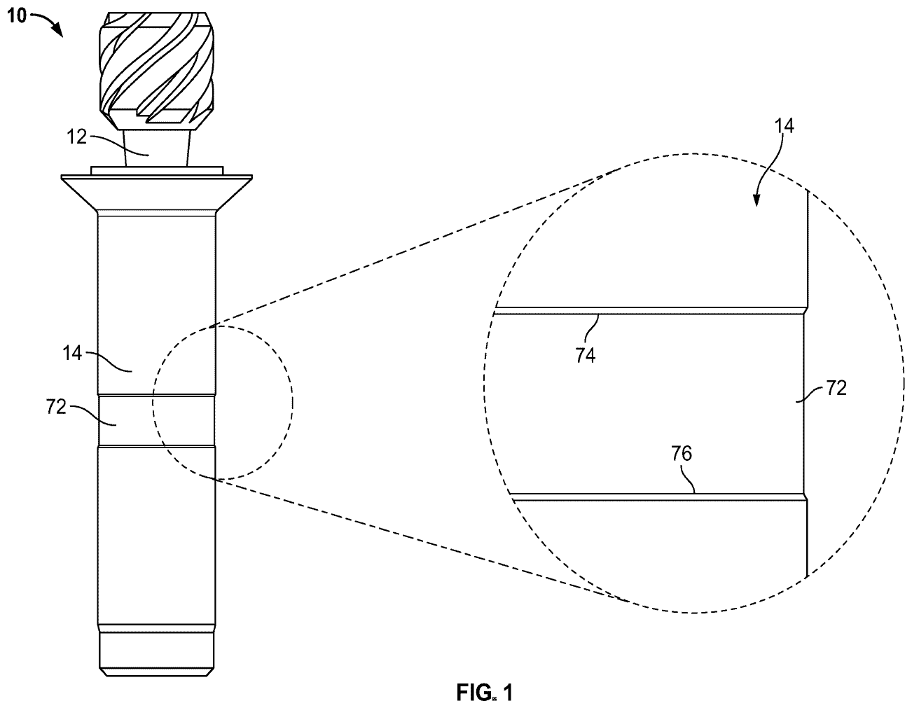

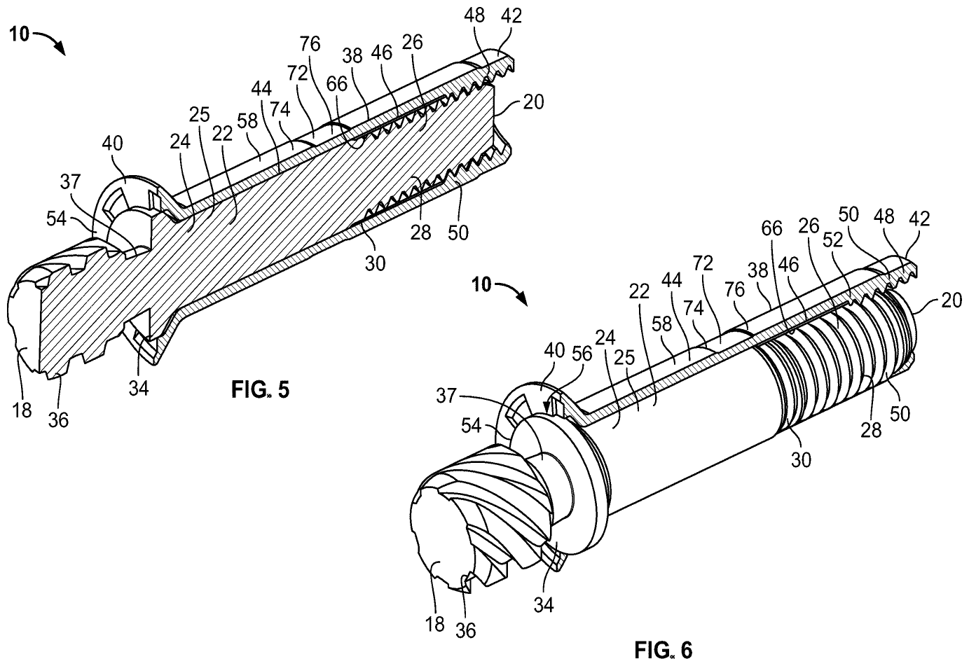

Referring to FIGS. 1 through 6, in some embodiments, a fastener 10 includes a core bolt 12 and a sleeve 14. In some embodiments, the sleeve 14 is sized and shaped to receive the core bolt 12, which will be described in further detail below.

In some embodiments, the core bolt 12 includes a first end 18, a second end 20 opposite the first end 18, and a shank portion 22 between the first end 18 and the second end 20. In some embodiments, the shank portion 22 includes a cylindrical portion 24 that includes an external surface 25. In some embodiments, the cylindrical portion 24 is proximate to the first end 18. In some embodiments, the shank portion 22 is a smooth cylindrical shank portion. In some embodiments, the shank portion 22 has a first diameter. In some embodiments, the shank portion 22 includes a threaded portion 26.

In some embodiments, the threaded portion 26 is proximate to the second end 20. In some embodiments, the threaded portion 26 includes an external thread 28. In some embodiments, the external thread 28 has a major diameter. In some embodiments, the major diameter is less than the first diameter of the shank portion 22. In some embodiments, the core bolt 12 includes a thread runout 30. In some embodiments, the thread runout 30 is located between the cylindrical portion 24 and the threaded portion 26. In some embodiments, the core bolt 12 is configured to be disposed within the sleeve 14. In some embodiments, the core bolt 12 includes an annular groove 32. In some embodiments, the annular groove 32 is adjacent to the thread runout 30. In some embodiments, the core bolt 12 includes a first head 34. In some embodiments, the first head 34 is proximate to the first end 18. In some embodiments, the first head 34 is a flush head. In some embodiments, the core bolt 12 includes a second head 36. In some embodiments, the second head 36 is located at the first end 18. In some embodiments, the second head 36 is a splined head. In some embodiments, the second head 36 is configured to be engaged by a fastener installation tool. In some embodiments, the second head 36 is removably attached to the first head 34. In some embodiments, the second head 36 is removably attached to the first head 34 by a breakneck portion 37. In some embodiments, the second head 36 is removed from the fastener 10 at the breakneck portion 37 after installation of the fastener 10.

Still referring to FIGS. 1 through 6, in some embodiments, the sleeve 14 includes a tubular portion 38. In some embodiments, the tubular portion 38 includes a first end 40, a second end 42 opposite the first end 40, a first portion 44 proximate to the first end 40 and having a first inner diameter, and a second portion 46 proximate to the second end 42. In some embodiments, the sleeve 14 includes an internal surface 66. In some embodiments, the second portion 46 includes an internal thread 48. In some embodiments, the internal thread 48 is located on the internal surface 66 of the second portion 46 of the sleeve 14. Referring to FIG. 3, in some embodiments, the sleeve 14 includes a third portion 50 adjacent the first portion 44. In some embodiments, the third portion 50 includes a second inner diameter that is less than the first inner diameter of the first portion 44. In some embodiments, the sleeve 14 includes an annular step 52. In some embodiments, the annular step 52 is located between the first portion 44 and the third portion 50. In some embodiments, the sleeve 14 does not include the annular step 52.

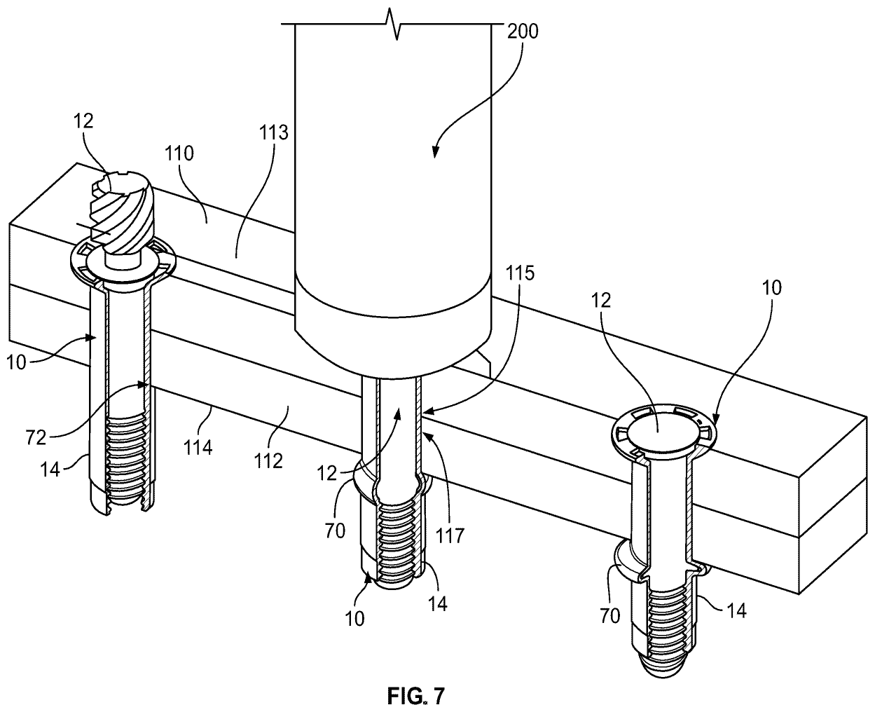

In some embodiments, the sleeve 14 includes a head 54. In some embodiments, the head 54 is located at the first end 40 of the tubular portion 38. In some embodiments, the head 54 is an enlarged head. In some embodiments, the head 54 includes a pocket 56. In some embodiments, the pocket 56 is sized and shaped to receive the first head 34 of the core bolt 12. In some embodiments, the sleeve 14 includes an external surface 58. In some embodiments, the external surface 58 of the tubular portion 38 of the sleeve 14 includes an outer diameter. In some embodiments, the outer diameter of the external surface 58 is sized and shaped to enable the sleeve 14 to be installed within aligned holes 115, 117 of a plurality of workpieces 110, 112 (see FIG. 7).

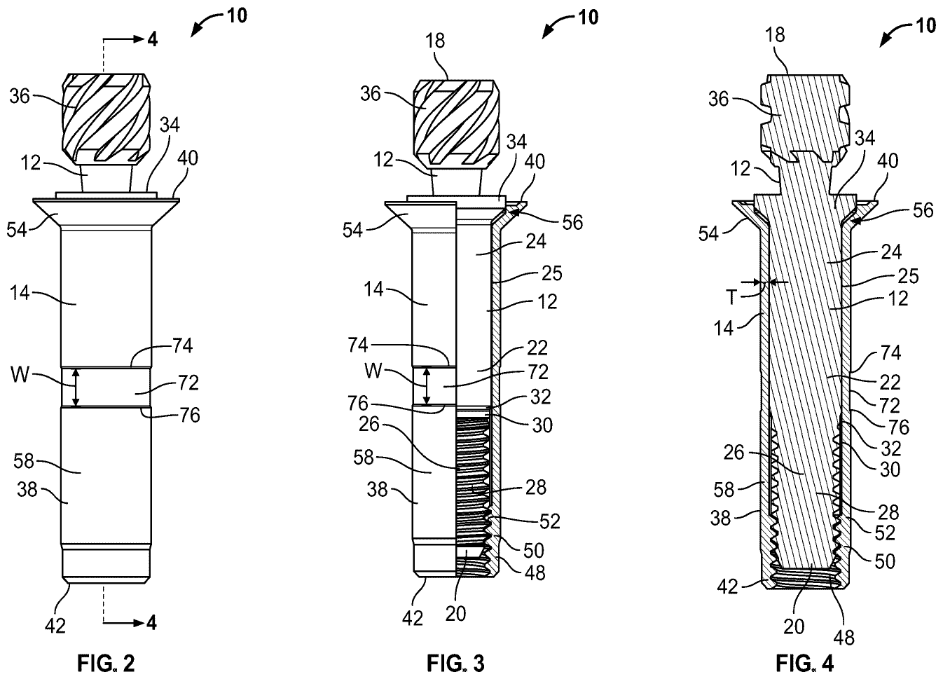

In some embodiments, the sleeve 14 includes a groove 72 located in the external surface 58 thereof (see FIG. 2). In some embodiments, the groove 72 circumferentially extends within the external surface 58. In some embodiments, the groove 72 circumferentially extends within the external surface 58 around the entire outer diameter of the sleeve 14. In some embodiments, the groove 72 partially circumferentially extends within the external surface 58 around the diameter of the sleeve 14. In some embodiments, the groove 72 has a depth of 0.001 inch to 0.005 inch. In some embodiments, the groove 72 has a depth of 0.001 inch. In some embodiments, the groove 72 has a depth of 0.002 inch. In some embodiments, the groove 72 has a depth of 0.003 inch. In some embodiments, the groove 72 has a depth of 0.004 inch. In some embodiments, the groove 72 has a depth of 0.005 inch. In some embodiments, the groove 72 has a first boundary 74 and a second boundary 76. In some embodiments, the first boundary 74 is spaced from the second boundary 76. In some embodiments, the groove 72 has a width W. In some embodiments, the width W extends from the first boundary 74 to the second boundary 76. In some embodiments, the width W is 0.06 inch to 0.1 inch. In some embodiments, the width W is 0.06 inch to 0.15 inch.

In some embodiments, the sleeve 14 has a wall thickness T of 0.01 to 0.05 inch. In some embodiments, a wall thickness of the sleeve 14 at the location of the groove 72 is thinner than the wall thickness T of other portions of the sleeve 14 that do not include the groove 72.

In some embodiments, the first diameter of the cylindrical portion 24 of the core bolt 12 is sized and shaped to enable the core bolt 12 to be installed within the sleeve 14. In some embodiments, the external thread 28 of the threaded portion 26 of the core bolt 12 is complementary to and configured to threadedly engage the internal thread 48 of the sleeve 14. In some embodiments, the core bolt 12 is configured to be engaged by a fastener installation tool 200 (see FIG. 7).

In some embodiments, the sleeve 14 is composed of A286 (AISI 660) steel. In some embodiments, the A286 steel is an austenitic precipitation hardening stainless steel. In some embodiments, the sleeve 14 is composed of a 300 series stainless steel. In some embodiments, the sleeve 14 is composed of 304L stainless steel. In some embodiments, the sleeve 14 is composed of 316L stainless steel. In some embodiments, the sleeve 14 is composed of a copper-nickel alloy. In some embodiments, the steel is modified to include a soft layer on the external surface 58 of the sleeve 14. In some embodiments, the term “soft” as defined herein means the layer on the external surface 58 of the sleeve 14 has a hardness of less than Rc 30 on the Hardness Rockwell Scale C.

In some embodiments, the steel is modified to include a hard layer on the internal surface 66 of the sleeve 14. In some embodiments, the term “hard” as defined herein means the layer on the internal surface 66 of the sleeve 14 has a hardness of 8.0 to 8.5 on the Mohs scale. In some embodiments, a first layer on the external surface 58 of the sleeve 14 includes a first hardness. In some embodiments, a second layer on the internal surface 66 of the sleeve 14 includes a second hardness. In some embodiments, the second hardness of the internal surface 66 of the sleeve 14 is greater than the first hardness of the external surface 58 of the sleeve 14. In some embodiments, the sleeve 14 includes a selectively soft deformable external surface and a selectively hard inner surface.

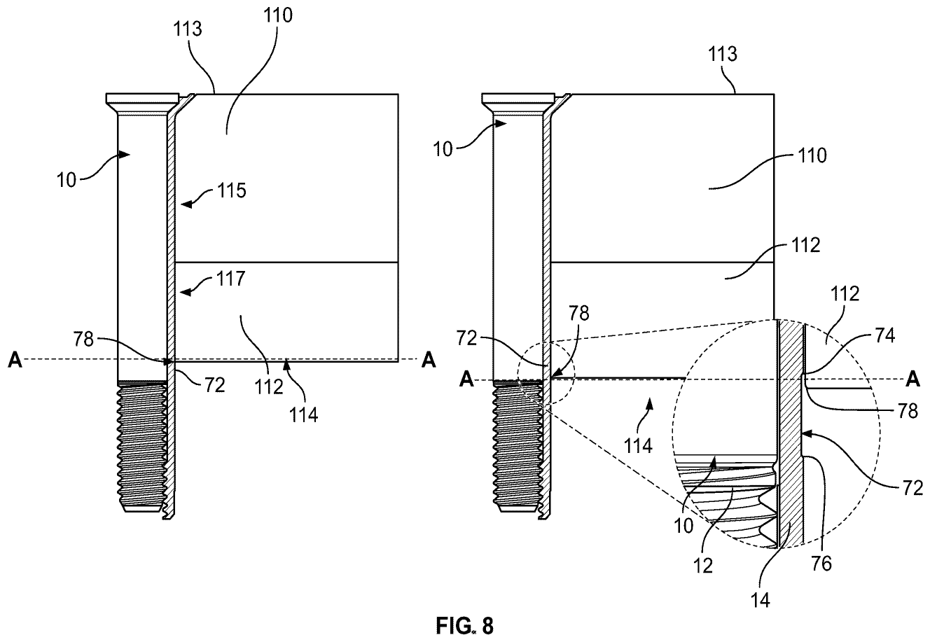

Referring to FIGS. 7 and 8, in some embodiments, the fastener 10 is configured to be installed in the aligned holes 115, 117 of the plurality of workpieces 110, 112. In some embodiments, the fastener 10 is assembled and pre-installed within the plurality of workpieces 110, 112. In some embodiments, the workpiece 110 includes an accessible side 113. In some embodiments, the workpiece 112 includes a blind side 114. In some embodiments, the accessible side 113 is opposite the blind side 114. In some embodiments, an installer of the fastener 10 does not have physical or visible access to the blind side 114 thereof. In some embodiments, each of the aligned holes 115, 117 of the workpieces 110, 112 includes an inner diameter. In some embodiments, each of the workpieces 110, 112 is composed of a composite material. In some embodiments, each of the workpieces 110, 112 is composed of a substantially composite material.

In some embodiments, the groove 72 is located within the external surface 58 of the sleeve 14 such that the backside grip line or plane A-A of the blind side 114 workpiece 112 is between the first boundary 74 and the second boundary 76 of the groove 72 (see FIG. 8). In some embodiments, the backside grip line A-A of the blind side 114 of the workpiece 112 is proximate to the first boundary 74. In some embodiments, the backside grip line A-A of the blind side 114 of the workpiece 112 is proximate to the second boundary 76. In some embodiments, the backside grip line A-A of the blind side 114 of the workpiece 112 is aligned with the first boundary 74. In some embodiments, the backside grip line A-A of the blind side 114 of the workpiece 112 is aligned with the second boundary 76. In some embodiments, the backside grip line A-A of the blind side 114 of the workpiece 112 is substantially aligned with the first boundary 74. In some embodiments, the backside grip line A-A of the blind side 114 of the workpiece 112 is substantially aligned with the second boundary 76.

In some embodiments, the groove 72 is configured to function as a hinge to facilitate the formation of the bulb 70 (see FIG. 7) without significantly elevating compressive stresses at a corner 78 of a hole 117 and the blind side 114 of the workpiece 112. In some embodiments, the hinge function of the groove 72 mitigates the possibility of delamination of the workpiece 112 at the corner 78.

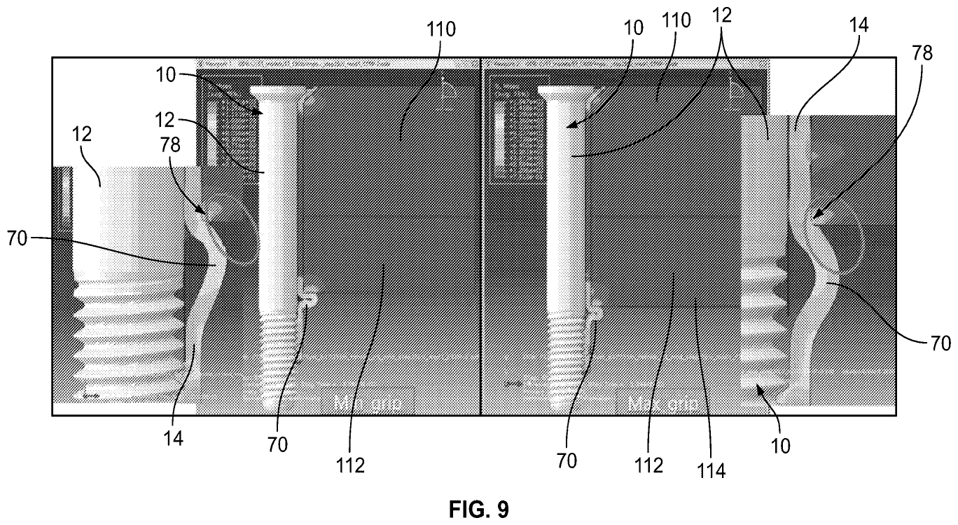

Referring to FIGS. 7 and 9 through 11, in some embodiments, the groove 72 facilitates the formation of a bulb 70 against the surface of the blind side 114 of the workpiece 112 in all grip ranges of the fastener 10 when the core bolt 12 is installed within the sleeve 14. In some embodiments, axial stress on the sleeve 14 is concentrated on the bulb 70 as the sleeve 14 is compressed by tightening the core bolt 12 during installation of the fastener 10.

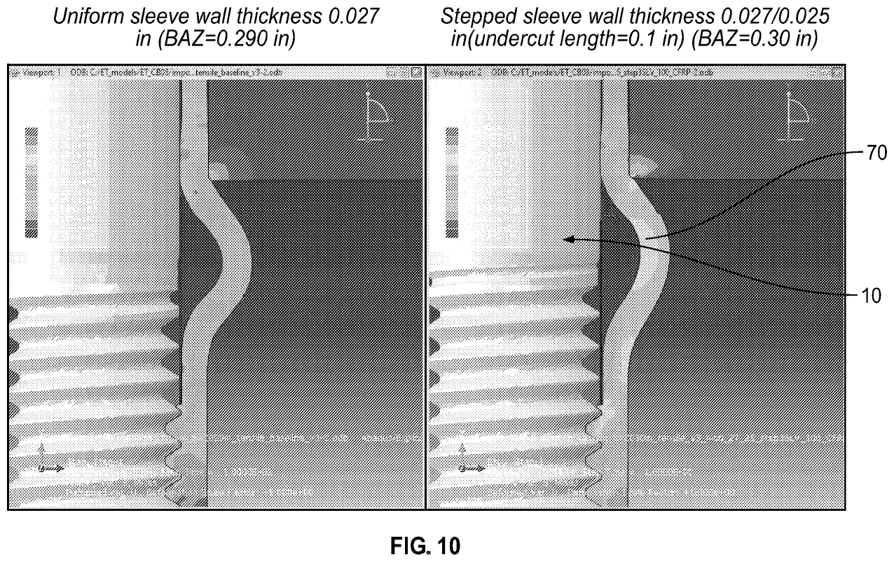

In some embodiments, the groove 72 enables the sleeve 14 with a thicker wall thickness to be buckled with lower axial force during installation of the fastener 10, which, in turn, requires a lower drive torque. FIG. 10 illustrates some embodiments of the bulb 70 formation comparison between the fastener 10 having the groove 72 (right figure) and a fastener without the groove 72 (left figure) at a minimum grip at four (4) turns of the core bolt 12 relative to the sleeve 14. In some embodiments, the fastener in the left side of the figure (without the groove) includes a uniform sleeve wall thickness of 0.027 inch. In some embodiments, the fastener 10 in the right side of the figure (with the groove 72) includes a stepped sleeve wall thickness of 0.027 inch and 0.025 inch, with an undercut length of 0.1 inch.

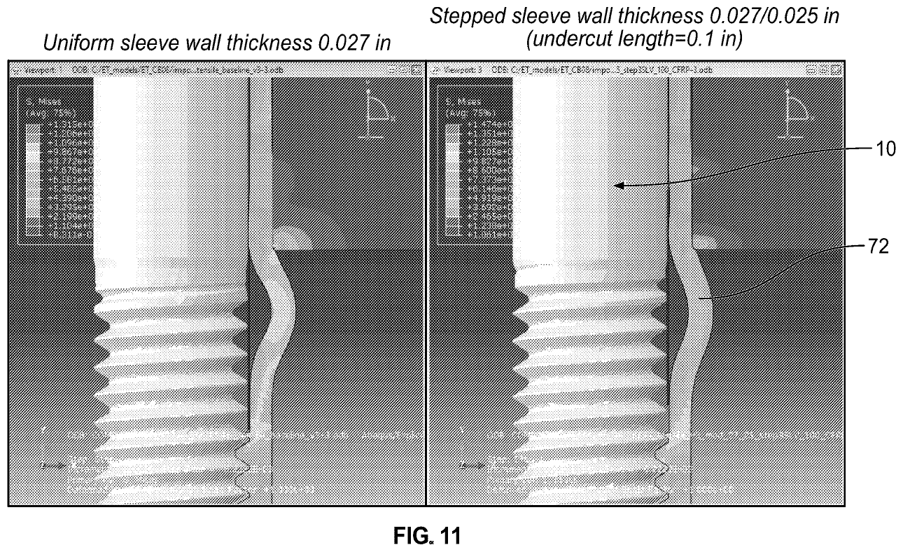

FIG. 11 illustrates some embodiments of the bulb 70 formation comparison between the fastener 10 having the groove 72 (right figure) and a fastener without the groove 72 (left figure) at a maximum grip at two and one-half (2.5) turns of the core bolt 12 relative to the sleeve 14. In some embodiments, the fastener in the left side of the figure (without the groove) includes a uniform sleeve wall thickness of 0.027 inch. In some embodiments, the fastener 10 in the right side of the figure (with the groove 72) includes a stepped sleeve wall thickness of 0.027 inch and 0.025 inch, with an undercut length of 0.1 inch.

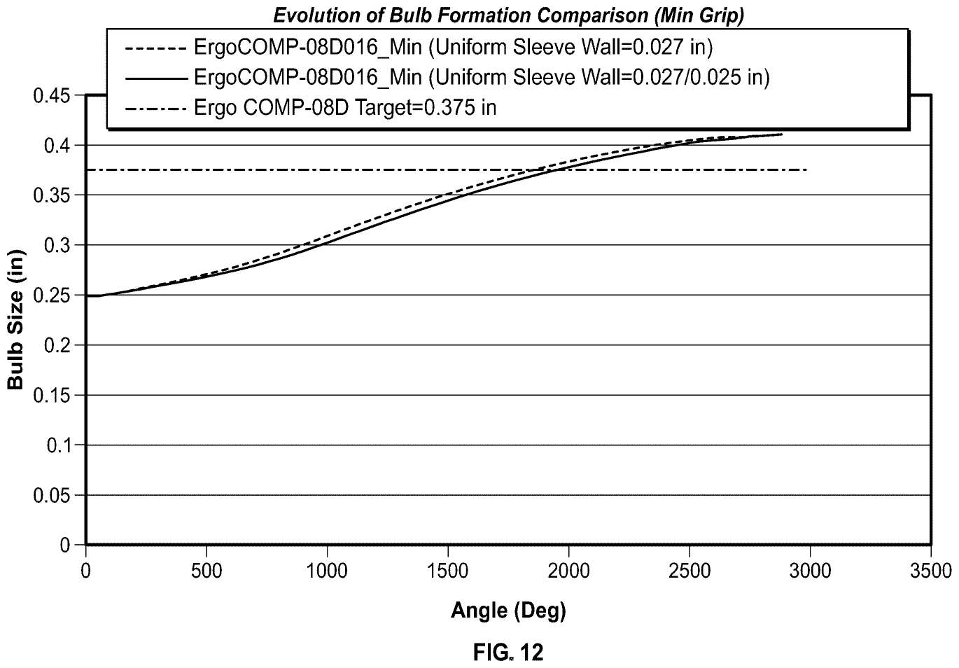

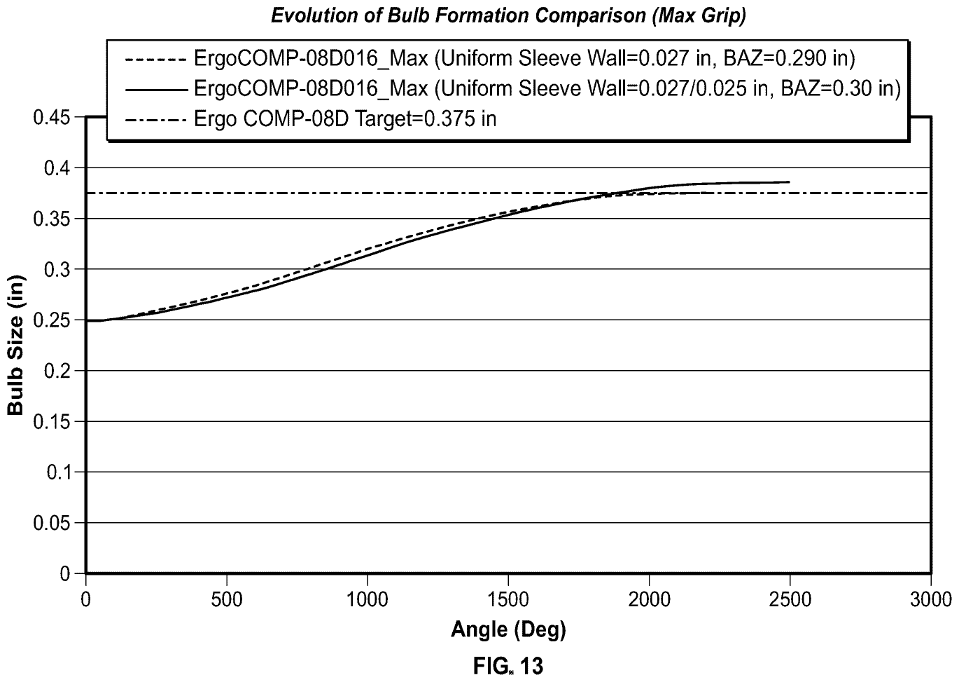

FIG. 12 illustrates a graph of bulb size versus drive angle of a bulb 70 formation comparison between the fastener 10 having the groove 72 and some embodiments of a fastener without the groove 72 at a minimum grip condition. FIG. 13 illustrates a graph of bulb size versus drive angle of a bulb 70 formation comparison between the fastener having the groove 72 and some embodiments of a fastener without the groove 72 at a maximum grip condition.

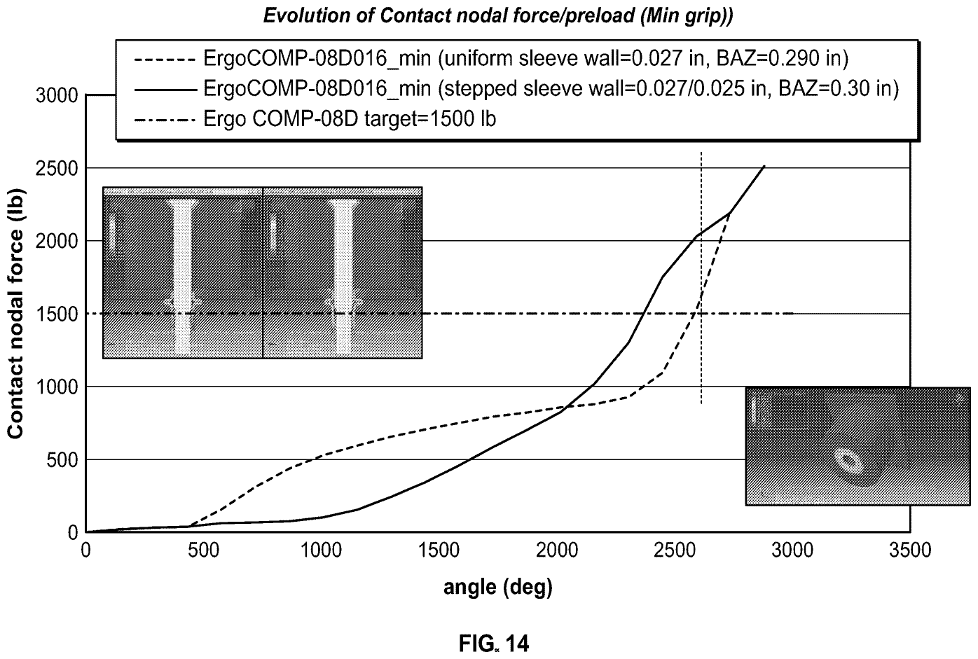

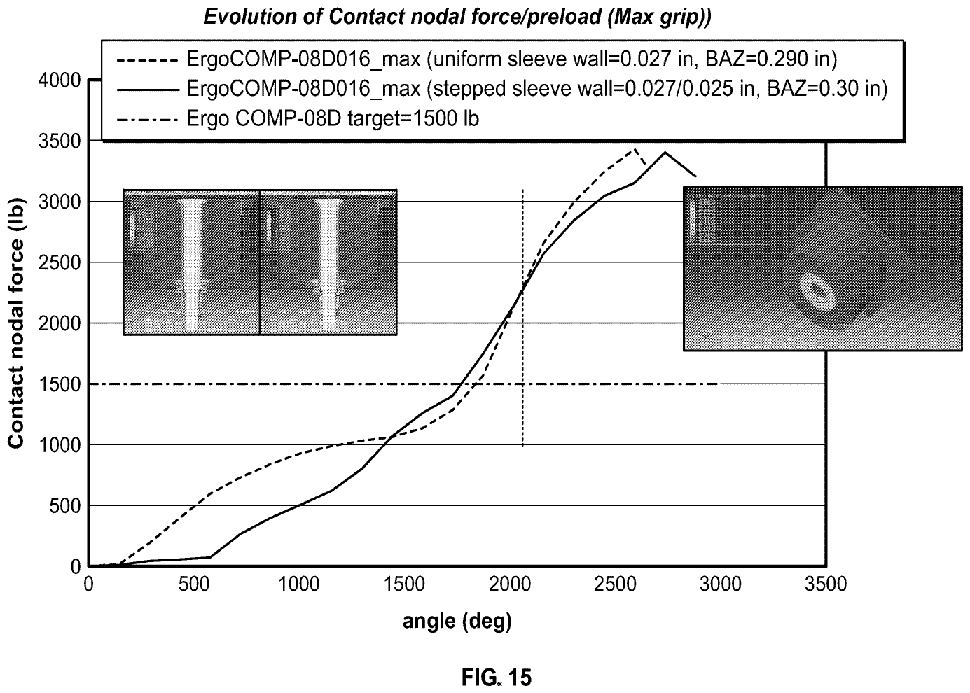

FIG. 14 illustrates a graph of contact nodal force versus drive angle of a comparison between the fastener 10 having the groove 72 and some embodiments of a fastener without the groove 72 at a minimum grip condition. FIG. 15 illustrates a graph of contact nodal force versus drive angle of a comparison between the fastener 10 having the groove 72 and some embodiments of a fastener without the groove 72 at a minimum grip condition. In some embodiments, the groove 72 facilitates a delay in the development of clamping force (i.e., preload) during installation of the fastener 10. In some embodiments, the fastener 10 is configured to have an equal or greater preload at a select grip condition at a specified target torque during installation of the fastener 10.

FIG. 15 illustrates Table 1 of examples of the fastener 10 under a minimum or maximum grip condition and associated diameters of the bulb 70, preload and ultimate tensile strength (UTS), as compared to target figures thereof.

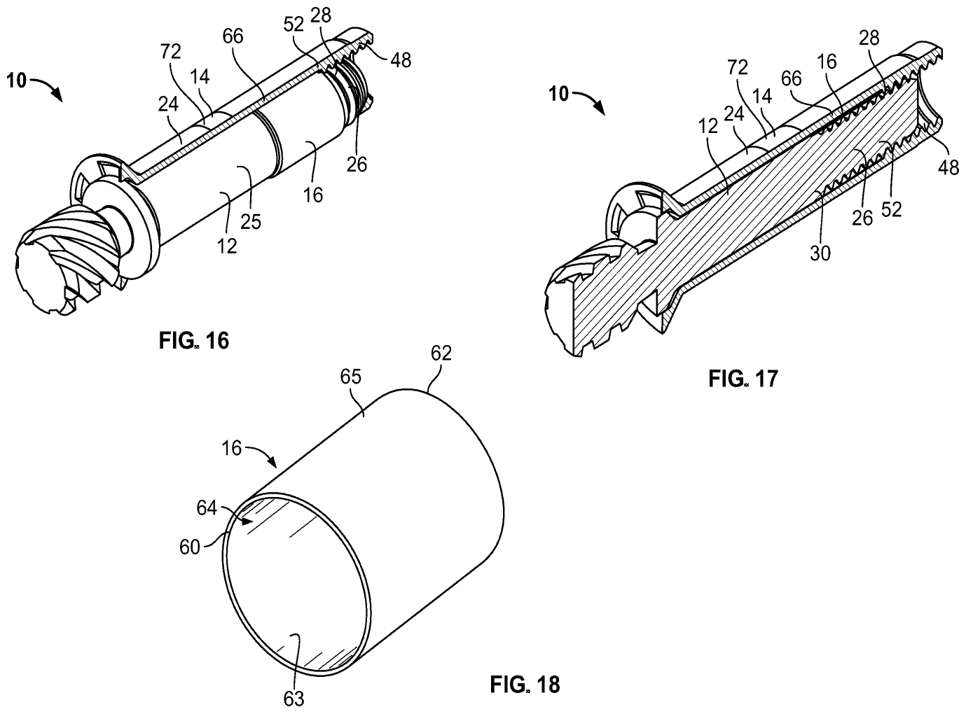

Referring to FIGS. 16 and 17, in some embodiments, the fastener 10 includes an insert 16 located between the internal surface 66 of the sleeve 14 and the external surface of the core bolt 12. In some embodiments, the insert 16 is disposed within the sleeve 14. In some embodiments, the insert 16 encircles at least a portion of the threaded portion 26 of the core bolt 12. In some embodiments, the insert 16 encircles the threaded portion 26 of the core bolt 12 in its entirety. In some embodiments, the insert 16 is sized and shaped to abut and be retained between the internal thread 48 of the sleeve 14 and the thread runout 30 of the core bolt 12 when the fastener 10 is in a pre-installation position. In some embodiments, the insert 16 is sized and shaped to abut and be retained between the annular step 52 of the sleeve 14 and the thread runout 30 of the core bolt 12 when the fastener 10 is in a pre-installation position.

Referring to FIG. 18, in some embodiments, the insert 16 includes a first end 60, a second end 62 opposite the first end 60, and an internal surface 63. In some embodiments, the internal surface 63 of the insert 16 forms an aperture 64. In some embodiments, the aperture 64 extends from the first end 60 to the second end 62 of the insert 16. In some embodiments, the insert 16 includes an external surface 65. In some embodiments, the insert 16 has a tubular shape. In some embodiments, the internal surface 63 is cylindrical in shape. In some embodiments, the insert 16 has an internal diameter. In some embodiments, the internal diameter of the insert 16 is larger than the major diameter of the external thread 28 of the core bolt 12 (see FIGS. 16 and 17). In some embodiments, the insert 16 has an outside diameter. In some embodiments, the outside diameter of the insert 16 is smaller than the smallest internal diameter of the sleeve 14. In some embodiments, the insert 16 is composed of copper. In some embodiments, the insert 16 is composed of Monel® alloy. In some embodiments, the insert 16 is coated. In some embodiments, the insert 16 is coated with a highly electrically conductive coating. In some embodiments, the coating is composed of a conductive metallic material. In some embodiments, the coating is composed of silver. In some embodiments, the coating is composed of gold. In some embodiments, the coating is composed of nickel. In some embodiments, the coating is composed of cadmium. In some embodiments, the coating includes a low coefficient of friction. In some embodiments, the coefficient of friction is less than 0.50.

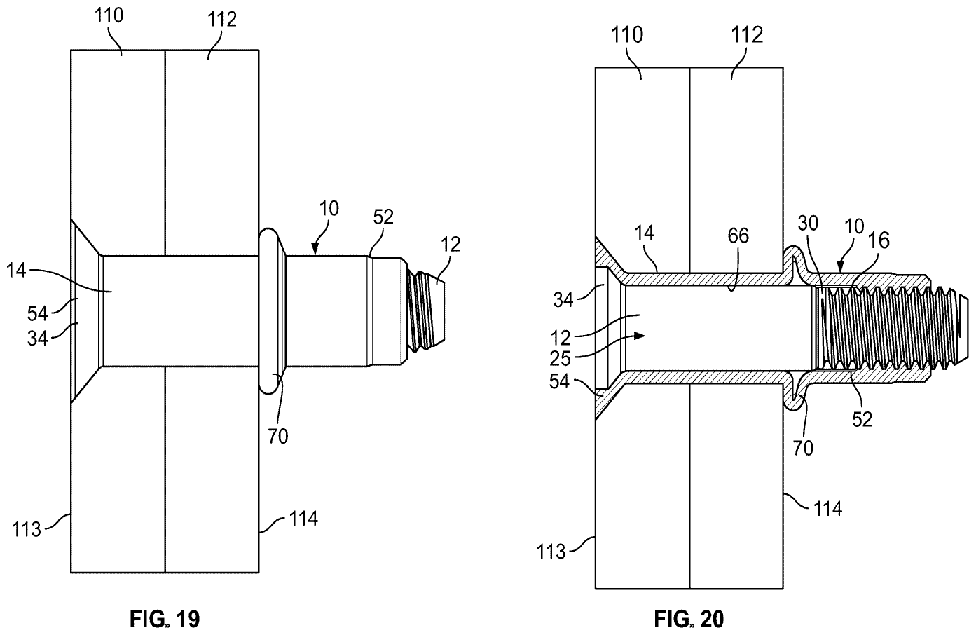

Referring to FIGS. 19 and 20, in some embodiments, during installation of the fastener 10, the insert 16 is compressed between the annular step 52 of the sleeve 14 and the thread runout 30 of the core bolt 12 by an installation motion of the core bolt 12 with respect to the sleeve 14 simultaneously with the installation motion of the core bolt 12. In some embodiments, the length of the insert 16 is configured such that a total volume of the insert 16 is complementary to a total volume of a void located between the internal surface 66 of the sleeve 14 and the external surface 25 of the core bolt 12, so as to fill the void between the core bolt 12 and the sleeve 14 when the fastener 10 is fully installed within the workpieces 110, 112. In some other embodiments, during installation of the fastener 10, the insert 16 is compressed between the internal thread 48 of the sleeve 14 and the thread runout 30 of the core bolt 12 by an installation motion of the core bolt 12 with respect to the sleeve 14 simultaneously with the installation motion of the core bolt 12, which generates a compressive load on the sleeve 14.

In some embodiments, the insert 16 is configured to be compressed between the internal thread 48 of the sleeve 14 and the thread runout 30 of the core bolt 12 by an installation motion of the core bolt 12 with respect to the sleeve 14 simultaneously with a generation of a compressive load on the sleeve 14 by the installation motion of the core bolt 12. In some embodiments, the insert 16 is configured to deform simultaneously with and facilitate a formation of a bulb 70 in the tubular portion 38 of the sleeve 14 in response to compression of the insert 16. In some embodiments, the insert 16 is configured to deform simultaneously with and, in conjunction with the groove 72, facilitate a formation of a bulb 70 in the tubular portion 38 of the sleeve 14 in response to compression of the insert 16. In some embodiments, the insert 16 is configured to function as a bearing during the installation process and fill a void between the internal surface 66 of the sleeve 14 and an external surface 25 of the core bolt 12 to form an electrically conductive path between the core bolt 12 and the sleeve 14.

In some embodiments, the external surface 58 of the sleeve 14 is coated with a soft, highly conductive coating. In some embodiments, the coating has sufficient electrical conductivity. In some embodiments, the coating is galvanically compatible with the sleeve 14. In some embodiments, the coating is galvanically compatible with the workpieces 110, 112. In some embodiments, the coating conforms with an inherent micro-texture of each of the inner surfaces formed by the respective holes 115, 117 in the workpieces 110, 112. In some embodiments, the coating is composed of a metal-based coating. In some embodiments, the coating is composed of silver. In some embodiments, the coating is composed of gold. In some embodiments, the coating is composed of nickel. In some embodiments, the coating is composed of zinc. In some embodiments, the coating is composed of cadmium. In some embodiments, the coating is composed of copper. In some embodiments, the coating is composed of lead. In some embodiments, the coating is composed of an alloy. In some embodiments, the coating is composed of bronze. In some embodiments, the coating is a polymer based coating.

In some embodiments, the external surface 58 of the sleeve is not coated. In some embodiments, the external surface 58 of the sleeve 14 is micro-textured. In some embodiments, the micro-texture of the external surface 58 of the sleeve 14 complements the micro-texture inherent to the inner surface forming the holes 115, 117 of each of the workpieces 110, 112. In some embodiments, the micro-texture is 25 micro inch to 40 micro inch.

In some embodiments, the internal surface 66 of the sleeve 14 includes a layer with a higher surface hardness as compared with a hardness of the internal surface 66 being untreated. In some embodiments, the internal surface 66 of the sleeve 14 has a surface hardness of 8.0 to 8.5 on the Mohs scale. In some embodiments, a first friction coefficient between the internal surface 66 of the sleeve 14 and the external surface 25 of the core bolt 12, and a second friction coefficient between the internal surface 66 of the sleeve 14 and the external surface 65 of the insert 16 is selected to facilitate sliding contact between the sleeve 14 and the core bolt 12 and the insert 16 during installation of the fastener 10. In some embodiments, the first friction coefficient is less than 0.5. In some embodiments, the second friction coefficient is less than 0.5. In some embodiments, the friction at the interface between the internal surface 66 of the sleeve 14 and the external surface 25 of the core bolt 12, and the friction at the interface between the internal surface 66 of the sleeve 14 and the external surface 65 of the insert 16, are reduced by the presence of an oxide layer. In some embodiments, the oxide layer includes a high hardness. In some embodiments, the oxide layer has a hardness of 8.0 to 8.5 on the Mohs scale. In some embodiments, the internal surface 66 of the sleeve 14 includes a dual layer. In some embodiments, the dual layer of the internal surface 66 of the sleeve 14 comprises nitrogen and carbon in a first layer and carbon in a second layer. In some embodiments, the first layer of the internal surface 66 of the sleeve 14 is an innermost layer. In some embodiments, the first layer of the internal surface 66 of the sleeve 14 is an outermost layer. In some embodiments, the second layer of the internal surface 66 of the sleeve 14 is an innermost layer. In some embodiments, the second layer of the internal surface 66 of the sleeve 14 is an outermost layer. In some embodiments, as compared with the internal surface 66 of the sleeve 14 being untreated, the microhardness of the internal surface 66 of the sleeve 14 having the dual layer is increased by a factor of two to three. In some embodiments, the microhardness of the internal surface 66 of the sleeve 14 is 8.0 to 8.5 on the Mohs scale.

In some embodiments, a thick, hard oxide layer is selectively grown on the internal surface 66 of the sleeve 14. In some embodiments, the selectively grown thicker oxide layer on the inner surface of the sleeve 14 produces sufficient protection against surface damage and results in lower friction. In some embodiments, a thick, oxide layer is formed slowly at an elevated temperature. In some embodiments, the oxide layer grows up to several microns thick to provide a hard layer. In some embodiments, the hard layer separates the metallic counterparts of the core bolt 12 and the insert 16 from those of the sleeve 14 during the sliding action of the core bolt 12 and the insert 16 relative to the sleeve 14, thus avoiding surface damage and galling and high friction. In some embodiments, the hard layer has a corundum like fine grain structure resulting in a hard surface up to 9.0 on the Mohs scale on the external surface 58 of the sleeve 14.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

What is claimed is:

1. A fastener, comprising:
a sleeve comprising:
a first end and a second end opposite the first end;
a tubular portion having an external surface and an internal surface;
wherein a groove is formed within the external surface between the first end and the second end,
wherein the groove has a depth of 0.001 inch to 0.005 inch;
wherein an internal thread is formed within the internal surface at the second end, and a head is located at the first end; and
a core bolt including a first end and a second end opposite the first end of the core bolt, a cylindrical portion proximate to the first end of the core bolt, an external threaded portion proximate to the second end of the core bolt, and a thread runout between the cylindrical portion and the external threaded portion,
wherein the core bolt is configured to be disposed within the sleeve, and wherein the external threaded portion is configured to threadedly engage the internal thread of the sleeve,
wherein an installation motion of the core bolt within the sleeve generates a compressive load on the sleeve, and
wherein the groove is configured to facilitate a formation of a bulb in the sleeve in response to the compressive load.

2. The fastener of claim 1, wherein the groove has a width of 0.06 inch to 0.15 inch.

3. The fastener of claim 1, wherein the groove circumferentially extends around the sleeve.

4. The fastener of claim 3, wherein the groove circumferentially extends around an entirety of a diameter of the sleeve.

5. The fastener of claim 3, wherein the groove circumferentially extends partially around a diameter of the sleeve.

6. The fastener of claim 1, wherein the groove includes a first boundary and a second boundary, wherein the first boundary circumferentially extends around the sleeve, and wherein the second boundary circumferentially extends around the sleeve.

7. The fastener of claim 6, wherein a blind side grip line of a first one of a plurality of workpieces is between the first boundary and the second boundary of the groove.

8. The fastener of claim 7, wherein the blind side grip line of the first one of the plurality of workpieces is proximate to the first boundary.

9. The fastener of claim 7, wherein a blind side grip line of the first one of the plurality of workpieces is substantially aligned with the first boundary.

10. The fastener of claim 7, wherein the blind side grip line of the first one of the plurality of workpieces is proximate to the second boundary.

11. The fastener of claim 10, wherein a blind side grip line of the first one of the plurality of workpieces is substantially aligned with the second boundary.

12. The fastener of claim 1, wherein the sleeve includes a first layer on the external surface of the sleeve, wherein the first layer includes a first hardness, and a second layer on the internal surface of the sleeve, wherein the second layer includes a second hardness, and wherein the second hardness is greater than the first hardness.

13. The fastener of claim 12, wherein the first layer is a coating.

14. The fastener of claim 13, the coating is composed of a metal-based coating.

15. The fastener of claim 14, the coating is selected from the group consisting of silver, gold, nickel, cadmium, copper, and lead, or alloys thereof.

16. The fastener of claim 14, wherein the coating is composed of bronze.

17. The fastener of claim 12, wherein the second layer is composed of an oxide layer.

18. The fastener of claim 12, wherein the sleeve includes a third layer over the second layer.

19. The fastener of claim 18, wherein the second layer is composed of carbon and the third layer is composed of nitrogen and carbon.

20. The fastener of claim 1, further comprising an insert configured to be disposed within the sleeve and encircle a portion of the core bolt proximate to the second end thereof, wherein the insert is sized and shaped to abut and be retained between the internal thread of the sleeve and the thread runout of the core bolt when the fastener is in a pre-installation position, wherein the insert is configured to be compressed between the internal thread of the sleeve and the thread runout of the core bolt by an installation motion of the core bolt with respect to the sleeve simultaneously with a generation of a compressive load on the sleeve by the installation motion of the core bolt, and wherein the insert is configured to deform simultaneously with and facilitate a formation of a bulb in the sleeve in response to compression of the insert.

21. The fastener of claim 20, wherein the insert is configured to deform simultaneously with and facilitate, in conjunction with the groove, a formation of a bulb in the sleeve in response to compression of the insert.

22. The fastener of claim 21, wherein the core bolt includes an external surface, wherein the insert is configured to fill a void between the external surface of the core bolt proximate to the second end thereof and the internal surface of the sleeve proximate to the second end of the tubular portion of the sleeve, and wherein the insert is configured to provide an electrically conductive path between the sleeve and the core bolt.

23. The fastener of claim 22, wherein a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener.

24. The fastener of claim 1, wherein the core bolt includes a head at the first end thereof, and wherein the head of the sleeve includes a pocket sized and shaped to receive the head of the core bolt.
